(19) United States
(12) Patent Application Publication
(10) Pub. No.: US 2014/0078922 A1
(43) Pub. Date: Mar. 20, 2014

(54) Interference Detection

(71) Applicant: Renesas Mobile Corporation, Tokyo (JP)

(72) Inventor: Hongnian Xing, Espoo (FI)

(73) Assignee: Renesas Mobile Corporation, Tokyo (JP)

(21) Appl. No.: 14/031,370

(22) Filed: Sep. 19, 2013

(30) Foreign Application Priority Data
Sep. 20, 2012 (GB) 1216824.1

(51) Int. Cl. H04W 24/00; H04L 5/00

(52) U.S. Cl. CPC H04W 24/00; H04L 5/0032
USPC 370/252; 370/335

(57) ABSTRACT

Measures for enabling accurate and prompt inter-cell interference detection in a multi-cell environment. Such measures may include, at a network side of a cellular system, inputting a code-spreaded interleaved frequency division multiple access signal, despreading the inputted signal using a plurality of user-specific spreading codes including at least one spreading code of a user of a subject cell and at least one spreading code of a user of a neighboring cell, and detecting inter-cell interference information on the basis of user-related despreaded signals.

### TECHNICAL FIELD

The present invention relates to interference detection. In particular, but not exclusively, the present invention relates to measures (including methods, apparatuses and computer program products) for enabling inter-cell interference detection in a multi-cell environment.

### BACKGROUND

One of the potential problems for wireless network operators in recent and future systems is the lack of network capacity. This requires the operators to either find some new radio resources for extending their services (or improving their service quality) or to improve the efficiency of the currently used resources.

It is known that an improvement of the system efficiency can generally be achieved at either link level or network level. Due to the limitation defined in the Shannon theory, the capacity improvement due to techniques at link level (such as modulation, coding, and different kinds of diversity schemes) could not be significant. However, there is still room to reduce the overall overhead at link level. This may also be related to the network architecture design so that it is not only a link level issue. Meanwhile, the capacity improvement due to techniques at network level could be more favorable, since the freedom there is more significant. The system efficiency improvement at network level involves self-network optimization and network coordination optimization. The self-network optimization is usually applied for a single network using a single RAT (for a certain operator), while the network coordination optimization is usually applied to coordinate the resources under different RATs (from different operators).

One of the topics for the system efficiency improvement is based on the idea of local area environments. That is, the channel condition can be improved by reducing the cell size. A direct result of this is that the system performance can be improved so that higher throughput can be obtained. Meanwhile, either the link level or the system level (architecture) can be improved due to changes of the transmission conditions. Examples of local area environments in cellular systems involve the WLAN concept, i.e. any technologies in the IEEE 802 family, and the concept of femtocells which is widely used in current 3G and 4G investigations.

In cellular-based systems, the uplink efficiency is usually lower than the downlink efficiency, which is due to the fact that the base station (e.g. a WLAN access point, a home eNodeB, etc.) receives the signals from all its served users in the uplink. So, even if the base station can synchronize the users from different locations e.g. by timing advance, the combination of independent channel responses from different users still causes a lot of trouble for the base station to retrieve the signal from noise and interference.

In a multi-cell environment, even where intra-cell synchronization is ensured, corresponding problems specifically occur due to inter-cell interference at the base station of each cell. While such problems could be addressed by means of known interference cancellation/coordination schemes, proper and effective application of such interference cancellation/coordination schemes requires knowledge about the prevailing or emerging inter-cell interference at the base station, particularly on the uplink representing the bottleneck for overall system performance, which is required to be as accurate and prompt as possible.

Thus, there is a desire to enable accurate and prompt inter-cell interference detection in a multi-cell environment.

### SUMMARY

Various embodiments of the present invention aim at addressing at least part of the above issues and/or problems and drawbacks.

Various aspects of embodiments of the present invention are set out in the appended claims.

According to a first aspect of the present invention, there is provided a method for enabling inter-cell interference detection in a multi-cell environment, the method comprising:

inputting a code-spreaded interleaved frequency division multiple access signal;

despreading the inputted signal using a plurality of user-specific spreading codes including at least one spreading code of a user of a subject cell and at least one spreading code of a user of a neighboring cell; and

detecting inter-cell interference information on the basis of user-related despreaded signals.

According to a second aspect of the present invention, there is provided a method for enabling inter-cell interference detection in a multi-cell environment, the method comprising:

generating an interleaved frequency division multiple access signal for user data;

spreading, in the time domain, the generated interleaved frequency division multiple access signal using a user-specific spreading code of a user of a subject cell; and

outputting the code-spreaded interleaved frequency division multiple access signal for transmission in the subject cell.

According to a third aspect of the present invention, there is provided an apparatus for use in enabling inter-cell interference detection in a multi-cell environment, the apparatus being for use on a network side of a cellular system, the apparatus comprising a processing system arranged to cause the apparatus to:

input a code-spreaded interleaved frequency division multiple access signal;

despread the inputted signal using a plurality of user-specific spreading codes including at least one spreading code of a user of a subject cell and at least one spreading code of a user of a neighboring cell; and

detect inter-cell interference information on the basis of user-related despreaded signals.

According to a fourth aspect of the present invention, there is provided an apparatus for use in enabling inter-cell interference detection in a multi-cell environment, the apparatus being for use on a terminal side of a cellular system, the apparatus comprising a processing system arranged to cause the apparatus to:

generate an interleaved frequency division multiple access signal for user data;

spread, in the time domain, the generated interleaved frequency division multiple access signal using a user-specific spreading code of a user of a subject cell; and

output the code-spreaded interleaved frequency division multiple access signal for transmission in the subject cell.

According to a fifth aspect of the present invention, there is provided a computer program product comprising a set of instructions (e.g. computer-executable computer program code) which, when executed on a computerised device, is arranged to cause the device to carry out the method according to any of the aforementioned method-related aspects of the present invention.

Such computer program product may comprise or be embodied as a (tangible) computer-readable (storage) medium or the like on which the computer-executable computer program code is stored, and/or the program may be directly loadable into an internal memory of the computer or a processor thereof.

According to a sixth aspect of the present invention, there is provided a method for enabling inter-cell interference detection in a multi-cell environment, substantially in accordance with any of the examples as described herein with reference to and illustrated by the accompanying drawings.

According to a seventh aspect of the present invention, there is provided apparatus for use in enabling inter-cell interference detection in a multi-cell environment, substantially in accordance with any of the examples as described herein with reference to and illustrated by the accompanying drawings.

Advantageous further developments or modifications of the aforementioned aspects of the present invention are set out in the following.

By virtue of any one of the aforementioned aspects of the present invention, accurate and prompt inter-cell interference detection in a multi-cell environment, such as e.g. a local area cellular environment, is achieved.

More specifically, by way of embodiments of the present invention, there are provided measures and mechanisms for enabling accurate and prompt inter-cell interference detection in a multi-cell environment (in/for cellular communication systems). Thereby, corresponding enhancements are achieved in this regard.

Further features and advantages of the invention will become apparent from the following description of preferred embodiments of the invention, given by way of example only, which is made with reference to the accompanying drawings.

### BRIEF DESCRIPTION OF THE DRAWINGS

For a more complete understanding of embodiments of the present invention, reference is now made to the following description taken in connection with the accompanying drawings in which:

FIG. 1 shows a schematic diagram of an interference scenario in a multi-cell environment, for which embodiments of the present invention are applicable;

FIG. 2 shows a signaling diagram of a procedure according to embodiments of the present invention;

FIG. 3 shows a schematic block diagram of a system configuration according to embodiments of the present invention;

FIG. 4 shows a graph of amplitudes of different multi-carrier modulation schemes in the time domain;

FIG. 5 shows a schematic diagram of a time domain representation illustrating a structure of an IFDMA signal according to embodiments of the present invention;

FIG. 6 shows a schematic diagram of a time domain representation illustrating a spreading operation according to embodiments of the present invention;

FIG. 7 shows a schematic diagram of a time domain representation illustrating localized and distributed spreading code allocations according to embodiments of the present invention;

FIG. 8 shows a schematic block diagram of despreading and interference detection operations according to embodiments of the present invention;

FIG. 9 shows a flow chart of an interference detection procedure according to embodiments of the present invention;

FIG. 10 shows a flow chart of a coordinated handover procedure according to embodiments of the present invention; and

FIG. 11 shows a schematic block diagram of apparatuses according to embodiments of the present invention.

### DETAILED DESCRIPTION

Aspects of the present invention will be described herein below. More specifically, aspects of the present are described hereinafter with reference to particular non-limiting examples and embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain network configurations and deployments. As such, the description of embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein.

In particular, the present invention and its embodiments may be applicable in any (cellular) communication system and/or network deployment in which inter-cell interference occurs at a base station.

Hereinafter, various embodiments and implementations of the present invention and its aspects or embodiments are described using several alternatives. It is generally noted that, according to certain needs and constraints, all of the described alternatives may be provided alone or in any conceivable combination (also including combinations of individual features of the various alternatives).

According to embodiments of the present invention, in general terms, there are provided mechanisms, measures and means for enabling accurate and prompt inter-cell interference detection in a multi-cell environment.

Before describing embodiments of the present invention, details relating to inter-cell interference problems at a base station of a cell in a multi-cell environment, which can be addressed by embodiments of the present invention, are given for explanatory purposes.

In terms of system efficiency improvement, local area (LA) transmission, i.e. communication in a local area environment, can help to improve the data throughput due to channel stability. Otherwise, diversity is not an important issue for such local area transmission, since the channel is flat in time and frequency. So it may not make sense to compare such systems with interleaved or localized resource distributions. Furthermore, it may not make sense to consider the significant performance by RAKE receivers in general.

In this case, the interference from other users due to the common sharing of the resource in different domains (time, frequency, code, space, and so on) could be the main and critical issue. In fact, all communication systems are designed such that the users can share the resource without any interference at the input of the (wireless) channel. For the channel part, the LA channel does not destroy the orthogonality between users critically (due to the assumption of flat frequency response and invariant time response). Accordingly, a problem may mainly arise from the synchronization. That is, the orthogonality between the users cannot be preserved in a non-synchronized case.

In either the downlink case or the uplink case, the intra-cell synchronization is not a significant problem, even if an uplink timing advance scheme may induce some synchronization errors. But thanks to the cyclic prefix (CP) in normal OFDM-based multi-carrier systems, this kind of error does not necessarily lead to ISI and ICI. The main problem results from the inter-cell case, i.e. inter-cell interference. In general, the base stations are not synchronized with each other (since network synchronization is not available in most cases, even if there could be a link (such as X2) between base stations).

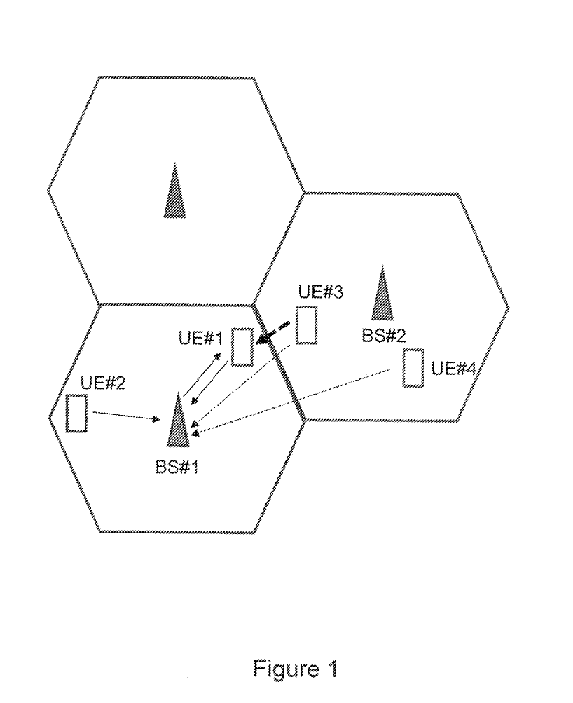

FIG. 1 shows a schematic diagram of an interference scenario in a multi-cell environment, for which embodiments of the present invention are applicable. The illustrated base stations BS#1 and BS#2 may generally be any kind of communication control element, such as e.g. a NodeB, an eNodeB, an access point, and so on. The terminals UE#1 through UE#4 may be any kind of communication element, especially but not exclusively any kind of mobile/wireless communication element, such as e.g. a mobile device, a mobile station, a user equipment, a telephone, a smartphone, a communicator, a (handheld) computer, a vehicle-mounted/based device, a navigation-related device, a server or a device with server functionality, and so on, respectively.

The thus illustrated multi-cell environment may for example be a LA environment, i.e. the base stations may be WLAN access points and/or home eNodeBs and/or the like. In FIG. 1, the cell of BS#1 is assumed to represent a subject cell, while the cell of BS#2 is assumed to represent a neighboring cell. Potential transmissions between the elements are illustrated by solid arrows, and potential interferences between the elements are illustrated by dashed arrows.

In the case of FIG. 1, UE#1 and UE#2 are assumed to be synchronized to base station BS#1, and UE#3 and UE #4 are assumed to be synchronized to base station BS#2. In the normal case, UE#3 and UE#4 will cause interference to UE#1 and UE#2, if they have some resource overlaps. Since UE#4 is far away from BS#1 (compared to UE#3), the inter-cell interference in the cell of BS#1 from the cell of BS#2 is mainly caused by UE#3. This is why the resource reuse factor 1 cannot be reached, especially at the cell edge.

In fact, if BS#1 and BS#2 are not synchronized, then UE#1 is not synchronized with its interference source UE#3 (and UE#4) and, thus, with its interference as such. In this case, the available resources for UE#3 are further reduced, since UE#3 cannot use not only the available resources for UE#1, but also not all the adjacent resources (for UE#1) due to the possible ICI (and ISI). Since one of the main drawbacks of OFDM is low side lobe attenuation, the interference could be rather significant. Meanwhile, the ISI is always there due to timing mismatch of the users from two adjacent cells. In general, the system efficiency could be rather low, since a significant amount of the resources cannot be reused, and the possible ISI in the time domain could be significant as well.

If TDD is used for the uplink/downlink switching, the trouble could be even more severe. In this case, UE#1 may stay at the downlink status (receiving from BS#1) while UE#3 stays at the uplink status (transmitting to BS#2). So, the possible inter-cell interference could be very strong, since UE#1 can receive the strong signal from UE#3 (since they are close to each other). In fact, even if UE#3 and UE#1 do not use the same resources, it is also possible that the strong out-band interference may be able to damage the performance of the receiver front-end (e.g. the analog-to-digital conversion) at UE#1.

Meanwhile, even if the base stations are synchronized with each other, the TDD uplink/downlink mismatch between inter-cell UEs cannot be completely removed, since all UEs have to be synchronized to their served base station first, respectively. Hence, their synchronization to their nearby base stations cannot be accurate. As said, this will lead to a significant efficiency loss, since it induces some correlations between uplink and downlink.

In an interference scenario in a multi-cell environment, such as that illustrated in FIG. 1, inter-cell interference cancellation/coordination is a critical issue. For enabling efficient inter-cell interference cancellation/coordination in such interference scenarios in a multi-cell environment, it is desirable to enable proper inter-cell interference detection, i.e. accurate and prompt inter-cell interference detection in a multi-cell environment.

In the following, embodiments of the present invention are described with reference to methods, procedures and functions, as well as with reference to structural arrangements and configurations.

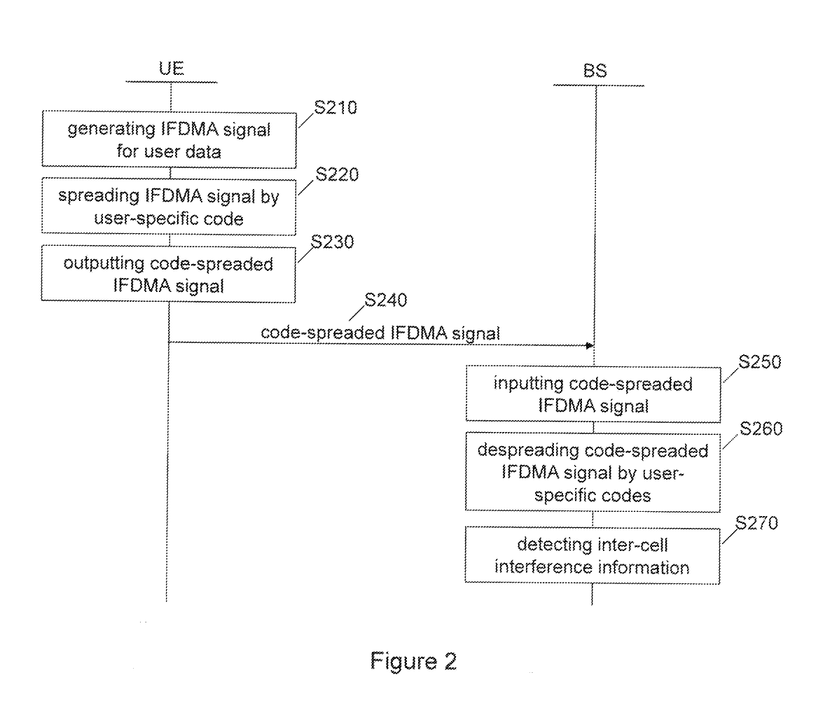

FIG. 2 shows a signaling diagram of a procedure according to embodiments of the present invention.

As shown in FIG. 2, a procedure according to embodiments of the present invention comprises the following operations/functions.

At the terminal side of a cellular system, i.e. at a user equipment, terminal or modem thereof (denoted by UE), there are performed an operation (S210) of generating an IFDMA signal for user data, an operation (S220) of spreading, in the time domain, the generated IFDMA signal using a user-specific spreading code of a user of a subject cell (i.e. the cell in which the UE is served), and an operation (S230) of outputting the code-spreaded IFDMA signal for transmission in the subject cell (i.e. to the serving base station).

Then, such code-spreaded IFDMA signal is communicated (S240) in the subject cell, including transmission from the UE and reception at the BS.

At the network side of a cellular system, i.e. at a base station (denoted by BS) such as an access point, an eNB, a home eNB, etc. or modem thereof, there are performed an operation (S250) of inputting the code-spreaded IFDMA signal, an operation (S260) of despreading the inputted signal using a plurality of user-specific spreading codes including at least one spreading code of a user of the subject cell and at least one spreading code of a user of at least one neighboring cell, and an operation (S270) of detecting inter-cell interference information on the basis of user-related despreaded signals.

While only a single UE is illustrated in FIG. 2 for the sake of simplicity, it is to be noted that such operation is effected at any UE of a system according to embodiments of the present invention. Also, while the communicated signal is illustrated in FIG. 2 to be directly transmitted and received at a single BS only for the sake of clarity, it is to be noted that such signal from any UE may be received both at the BS of the subject cell and a number of BSs of neighboring cells. Stated in other words, any BS in a system according to embodiments of the present invention may receive such signals from its served UEs (resulting in a desired signal) as well as from a number of non-served UEs from neighboring cells (resulting in inter-cell interference).

According to embodiments of the present invention, a technique for accurate and prompt detection of inter-cell interference (in particular, in the uplink) for multi-cell environments such as LA networks is thus based on utilization of an IFDMA-based time domain spreading. Stated in other words, a time domain spreading of an IFDMA signal by user-specific spreading codes enables an accurate and prompt detection of inter-cell interference (in particular, in the uplink) for multi-cell environments such as LA networks according to embodiments of the present invention.

By utilizing IFDMA signal features in the time domain, user-specific spreading codes are applied in the time domain, preferably after the last OFDM modulation stage at the TX side and prior to the first OFDM demodulation stage at the RX side. The capability and benefits of time domain spreading result from special IFDMA time domain signal features, as explained below. Accordingly, corresponding spreading and despreading operations are performed at the TX and RX sides, respectively.

According to embodiments of the present invention, said time domain spreading of an IFDMA signal is applicable for detecting, as the inter-cell interference information, inter-cell interference timing and/or inter-cell interference power and/or inter-cell interference user identification for one or more of the user-related despreaded signals. That is to say, embodiments of the present invention are effective for finding interference frame timing and (relative) power and/or identifying an interference user, for example.

According to embodiments of the present invention, said detected inter-cell interference information is applicable for inter-cell interference cancellation and/or inter-cell interference coordination and/or coordinated handover. That is to say, embodiments of the present invention are effective for designing multi-user detection and/or interference cancellation/coordination schemes, designing base station resource scheduling schemes, and/or executing a coordinated handover, for example.

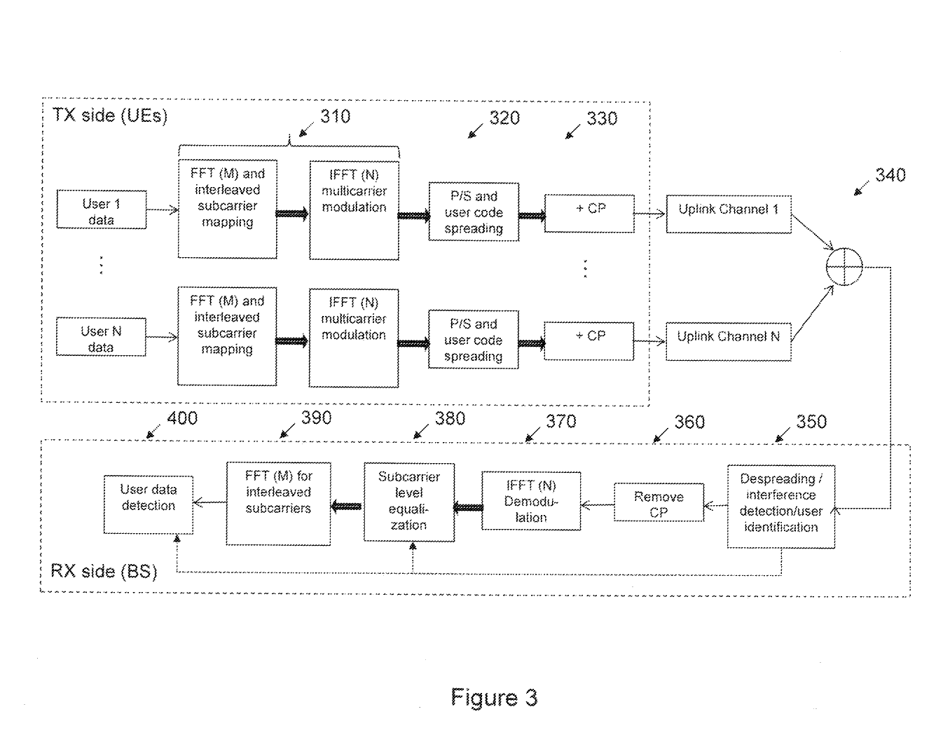

FIG. 3 shows a schematic block diagram of a system configuration according to embodiments of the present invention. It is to be noted that the system configuration according to FIG. 3 merely represents a non-limiting example, and various modifications thereto are feasible, particularly in terms of the usage of detected inter-cell interference information at the network side.

At the terminal side of a cellular system, i.e. at any UE of a system according to embodiments of the present invention, user data is subject to IFDMA signal generation in stage 310, in which an operation corresponding to that of S210 of FIG. 2 is applicable. Namely, the user data is subject to a FFT of length M (e.g. M=4) and interleaved subcarrier mapping, and then to a multi-carrier modulation with a longer IFFT of length N (e.g. N=12). The thus generated IFDMA signal is subject to parallel to serial conversion and time domain user code spreading in stage 320, in which an operation corresponding to that of S220 of FIG. 2 is applicable. In stage 330, a cyclic prefix (CP) is inserted in the thus code-spreaded IFDMA signal. It is to be noted that, instead of stage 330, such CP insertion could equally be applied in the IFDMA signal generation in stage 310 as well. The resulting signal is output after stage 330, wherein an operation corresponding to that of S230 of FIG. 2 is applicable. Then, the resulting signal is subject to transmission via a wireless channel towards the base station of the subject cell, wherein an operation corresponding to that of S240 of FIG. 2 is applicable. Accordingly, the individual signals of all UEs transmitting such signals are added on an uplink channel towards the network side.

At the network side of a cellular system, i.e. at any BS of a system according to embodiments of the present invention, a code-spreaded IFDMA signal is received and input, and then subject to despreading and detection of inter-cell interference information in stage 350, in which an operation corresponding to that of S250, S260 and S270 of FIG. 2 is applicable. As exemplified in FIG. 3, the inter-cell interference information detection of stage 350 could include interference (frame) detection and/or user identification. In the example system configuration according to FIG. 3, the thus despreaded received signal is further processed by being subject to removal of the inserted CP in stage 360, an IFFT demodulation in stage 370, a subcarrier level equalization in stage 380, an FFT for the interleaved subcarriers in stage 390, and user data detection in stage 400. Further, in the example system configuration according to FIG. 3, the inter-cell interference information detected in stage 350 is supplied as control data to the subcarrier level equalization in stage 380 and the user data detection in stage 400.

In the system configuration according to FIG. 3, as described above, (uplink) synchronization between the TX and RX sides is carried out before the data transmission. That is, all uplink users (UEs) will be synchronized with their serving base station, respectively. Such (uplink) synchronization can be achieved in a manner similar to conventional cellular communication systems such as LTE®/LTE-A (e.g. in that the base station provides a timing advance in the downlink for each individual user or UE so that each user or UE will be able to tune its timing accordingly). Accordingly, the outputting and/or transmission operations at the TX side and/or the inputting and/or despreading operations at the RX side are based on such time synchronization in the subject cell.

As evident from FIG. 3, the system according to embodiments of the present invention is based on an IFDMA system, in which a time domain user code spreading of stage 320 at the TX (terminal) side and inter-cell interference information detection of stage 350 at the RX (network) side are added.

The time domain spreading of the IFDMA signal at the TX side is used for enabling inter-cell interference information detection such as interference detection and interference identification at the RX side. To this end, each user is assigned a unique code (i.e. a single code) or a group of unique codes (i.e. a group of at least two codes) as the user-specific spreading code. At the RX side, for despreading purposes, the received signal is correlated (in time) with all codes and/or code groups available in the system.

In the time domain, some overlapped peaks (or peaks very close to each other) and some other peaks with random locations result from such correlation. The overlapped peaks (or peaks very close to each other) correspond to the served users of the subject cell, i.e. the UEs being served by the BS in question, since all its served users are synchronized. Since the utilized spreading codes are user-specific, the framing time for individual users as well as their corresponding subcarriers can be found/checked. The other peaks with random locations correspond to the non-served (interfering) users of one or more neighboring cells, i.e. the UEs being served by a BS other than the BS in question, since these users are not synchronized with the BS in question. That is, these peaks belong to inter-cell interference users, for which the corresponding user-specific spreading codes do not belong to the serving BS. Depending on their locations and (relative) powers, different processes may apply for different kinds of interference. In general, the detection information will be fed to an interference cancellation operation/block (which could be allocated in the time domain before multi-carrier demodulation, in the frequency domain at subcarrier level, or in the time domain after short FFT operation). Besides, the detection information can be used and/or given to a corresponding base station serving the user in question (e.g. by an X2 or similar connection) for their potential resource rescheduling and/or handover schemes.

As is generally known, the success or efficiency of user code spreading in the time domain is based on two basic factors, namely a constant value for spreading in the time domain, and a time-invariant channel at least in one symbol/spreading duration.

A time-invariant channel can for example be assumed to apply in LA networks/environments. Accordingly, embodiments of the present invention are specifically applicable in such LA networks/environments, such as networks/environments on the basis of the WLAN concept, i.e. any technologies in the IEEE 802 family, and/or the concept of femtocells or the like. This is because the LA channel is rather stable in time and frequency so that time domain averaging could be possible over several spreading durations to improve the performance (as the UE speed is typically smaller than 30 km/h).

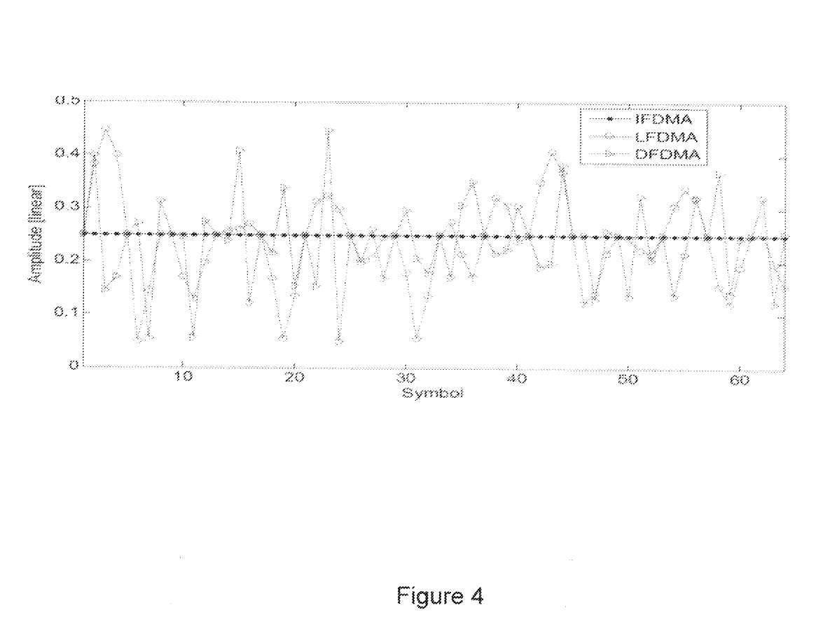

A constant value may be specifically assumed to apply in an IFDMA-based multi-carrier modulation. Accordingly, embodiments of the present invention are specifically applicable to IFDMA-based multi-carrier modulation. Conventional OFDM signals in the time domain are known to exhibit high PAPR values, which is why OFDM signals cannot be used for any time domain spreading. While any other block and localized SC-FDMA signals can provide better PAPR values, the data of such signals is still not constant in the time domain. The time domain signal of different multicarrier schemes is illustrated in FIG. 4.

FIG. 4 shows a graph of amplitudes of different multi-carrier modulation schemes, i.e. IFDMA, LFDMA and DFDMA, in the time domain. It is evident that only IFDMA exhibits constant amplitude. In fact, only constant amplitude is not enough, since the time domain spreading needs a constant (real or complex) value. Yet, such property is also achievable by IFDMA signals.

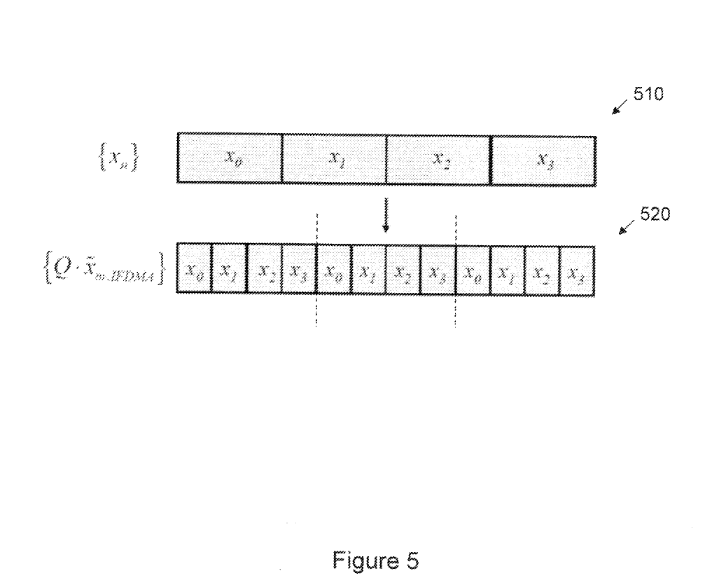

FIG. 5 shows a schematic diagram of a time domain representation illustrating a structure of an IFDMA signal according to embodiments of the present invention.

In FIG. 5, a set of four symbols of user data is denoted by 510, and a combined SC-FDMA symbol of a generated IFDMA signal is denoted by 520. The representations of FIG. 5 are based on the example that the short FFT length (M) is 4 and the longer IFFT length (N) is 12. Accordingly, a repetition rate of 3 results, i.e. a time domain symbol repetition value of a user data time domain symbol in a combined SC-FDMA symbol of the IFDMA signal. This means that each time domain symbol (x₀, x₁, x₂, x₃) repeats three times in one combined SC-FDMA symbol. In this case, the spreading factor of the time domain spreading would be 3.

In the case of N=1024 and M=16, each time domain symbol will repeat 64 times in one combined SC-FDMA symbol. Such a repetition with a repetition rate of 64 is sufficient for using a reasonable spreading factor of the time domain spreading of 64. Meanwhile, the code combination length is 16, which is why there is sufficient room to make different code group combinations.

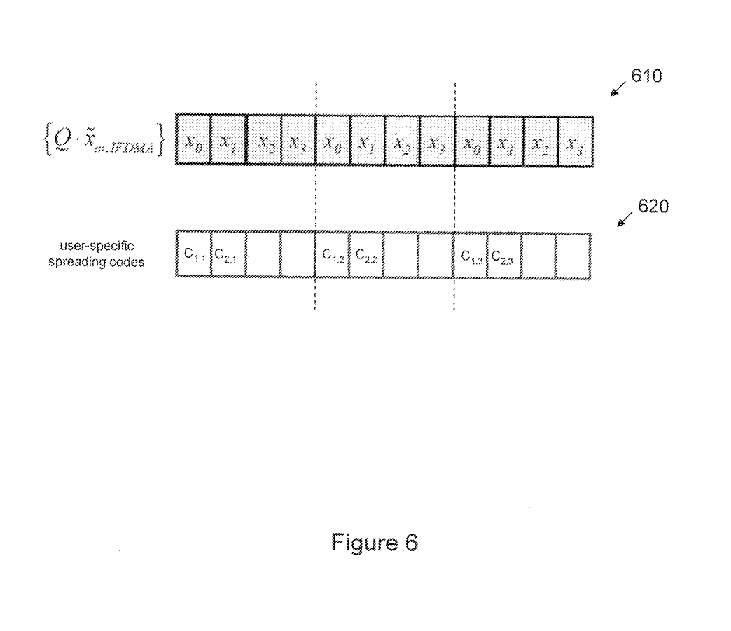

FIG. 6 shows a schematic diagram of a time domain representation illustrating a spreading operation according to embodiments of the present invention.

In FIG. 6, a combined SC-FDMA symbol of a generated IFDMA signal is denoted by 610, and user-specific spreading codes used for time domain spreading are denoted by 620. It is assumed that a single user is assigned with a spreading code including a set of two codes, each one having 3 chips or a spreading factor of 3 (corresponding to the underlying repetition rate). In such example, the time domain symbol x₀ is spreaded with c_{1,1} (chip 1 of code 1) at its first appearance in the combined SC-FDMA symbol, with c_{1,2} (chip 2 of code 1) at its second appearance in the combined SC-FDMA symbol, and c_{1,3} (chip 3 of code 1) at its third appearance in the combined SC-FDMA symbol. Likewise, the time domain symbol x₁ is spread with c_{2,1} (chip 1 of code 2) at its first appearance in the combined SC-FDMA symbol, with c_{2,2} (chip 2 of code 2) at its second appearance in the combined SC-FDMA symbol, and c_{2,3} (chip 3 of code 2) at its third appearance in the combined SC-FDMA symbol.

It is clear that a single code with enough length could be sufficient to provide both interference (frame timing) detection and interference (user) identification. However, as the repetition rate is limited, the single code length cannot be long. As a result, the available codes could cause problems if the code length is limited. In this case, a code group is thus used to combine different codes. Such code groups provide freedom of design as well as more accurate results.

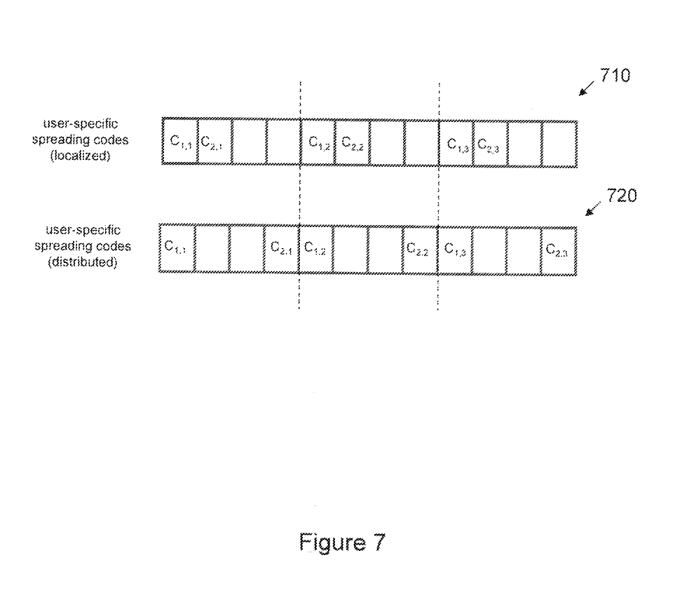

According to embodiments of the present invention, the user-specific spreading code may be allocated in a localized allocation or a distributed allocation with respect to time domain symbols in a symbol repetition set of time domain symbols, as shown in FIG. 7.

FIG. 7 shows a schematic diagram of a time domain representation illustrating localized and distributed spreading code allocations according to embodiments of the present invention.

In FIG. 7, a localized allocation of user-specific spreading codes (corresponding to the user-specific spreading codes 620 of FIG. 6) is denoted by 710, and a distributed allocation of user-specific spreading codes is denoted by 720. In consideration of the combined SC-FDMA symbol 610 of FIG. 6, it is evident that the chips of the same chip number of both codes are allocated adjacent to each other (in the present example, both at the beginning of a repetition set (x₀, x₁, x₂, x₃) of time domain symbols) in the localized allocation 710, while the chips of the same chip number of both codes are allocated with a gap there-between (in the present example, at the beginning and the end of a repetition set (x₀, x₁, x₂, x₃) of time domain symbols) in the distributed allocation 720.

If a number of symbols for M-FFT is large enough (i.e. if M is large enough), the position of the symbols for spreading could be beneficially considered. This is particularly effective, if the time domain signal is not completely invariant in a spreading duration. That is, there could be two kinds of code allocation, localized or distributed, used in a separate or combined manner. For a channel assumption such as for LA networks/environments there could be no significant difference between localized and distributed code allocations, thus both being applicable in equal measure. However, the different code allocations can be used in a combined manner as well. For example, the different code allocations can be used for frame timing and symbol (IFDMA symbol) timing, respectively. That is, the distributed code allocation can for example be used for the first (or last) IFDMA symbol of one frame, while the localized code allocation can for example be used for other IFDMA symbols. Thereby, the BS (e.g. the receiver or modem thereof) can detect if it is a start of a frame or a start of an IFDMA symbol based on the resulting peak distance.

According to embodiments of the present invention, as mentioned above, the user-specific spreading code may comprise a single code or a group of at least two codes. Further, the codes may be selected and/or grouped in various manners. For example, in a group of at least two codes, different CAZAC codes may be used, or a CAZAC code or an m sequence and a WH code may be used, or a root index of a CAZAC code and a cyclic shift of the CAZAC code may be used, as explained below.

A code selection/grouping may be such that CAZAC codes with good autocorrelation and cross correlation properties (such as Zadoff Chu codes) are used. In this case, different CAZAC codes may be dedicated for detection of inter-cell interference timing, inter-cell interference power, and inter-cell interference user identification. The timing/power detection and the user identification can be done by a single step. That is, when the peaks in the time domain are found (and the corresponding peak positions are checked), the timing can be found, and meanwhile the user/interference can be identified since the codes used to find the peaks are user-specific.

Another code selection/grouping may be such that a CAZAC code or m sequence and a WH code are used. In this case, a CAZAC code or an m sequence may be dedicated for detection of inter-cell interference timing and inter-cell interference power, and a WH code may be dedicated for detection of inter-cell interference user identification. The code used for timing/power detection may preferably be the CAZAC code or m sequence, since these provide a good autocorrelation property for finding the correct timing. After the frame/symbol timing (and the power) has been detected, the other code in the code group may be applied for the user identification. To this end, a WH code is preferably used, since it is completely orthogonal within each other (when the timing/phase is correct).

Still another code selection/grouping may be such that a root index of a CAZAC code and a cyclic shift of the CAZAC code may be used. In this case, a root index of a CAZAC code may be dedicated for detection of inter-cell interference timing and inter-cell interference power, and a cyclic shift of the CAZAC code may be dedicated for detection of inter-cell interference user identification. Thereby, the code design may be further simplified in that it is utilized that the cyclic shift of CAZAC codes (such as ZC sequence which is used for the first step of timing/power detection) could be used for the user identification in case the channel delay spread is short (which is one of the LA assumptions). In this case, ZC root indices could be used for different groups in the first step of timing/power detection, and different cyclic shifts of the same sequence could be used for the second step of user identification.

According to embodiments of the present invention, the code group may be formed as follows. The available codes should be equally distributed to a number of cells (i.e. the subject cell and its neighboring cells), e.g. to 7 cells in total. Then, each cell, i.e. each BS, could form the code groups on its own. The size of the code groups in each cell should be equal for all of the (e.g. 7) cells. If there are not enough code groups for a unique assignment to all the served users, the cells or base stations may use an extended scheme. On the one hand, new code groups with an extended size may be used. For example, if all the 2-sized code groups, i.e. code groups consisting of 2 codes each, have been used, the cells or base stations may use 3-sized code groups, i.e. code groups consisting of 3 codes each. On the other hand, the same code groups could be used with different code allocations (as illustrated in FIG. 7). In any case, it is to be ensured that there is no overlapping of any component code (inside a code group) between inter-cell users/interferences. This maximizes the accuracy of the interference timing/power detection and user identification.

According to embodiments of the present invention, as mentioned above, CP insertion can be effected in different ways, i.e. at different stages at the TX side.

A first conceivable design in this regard resides in that the CP insertion is part of the outputting operation/stage, i.e. the CP is inserted in the code-spreaded IFDMA signal. That is, the time domain spreading is done before the CP insertion. At the RX side, the CP is removed after the synchronization. None of the CP durations will be used for the time domain spreading.

A second conceivable design in this regard resides in that the CP insertion is part of the signal generation operation/stage, i.e. the CP is inserted in the IFDMA signal. That is, the time domain spreading is carried out after the CP insertion, thereby also using the CP duration for the time domain spreading. Since CP is a part of the IFDMA symbol in this case, it will contain some of the original data symbols. For example, if the CP is about 10% of the IFDMA symbol, and IFDMA symbol length is 1024 (64×16), then it is possible that the time domain spreading length can be extended (from 64) to 70. As the longer spreading indicates/achieves the larger process gain, this may give another criterion for the IFDMA CP design. That is, besides the channel delay spreading consideration, a proper CP may also need to be chosen so that the overall spreading code can be properly extended.

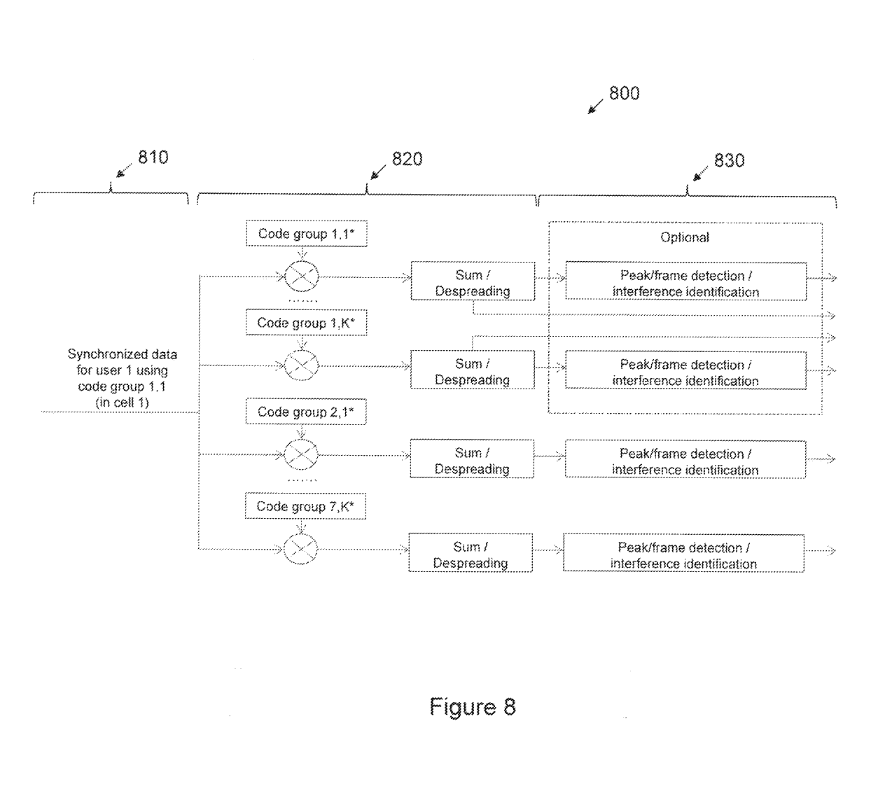

FIG. 8 shows a schematic block diagram of despreading and interference detection operations according to embodiments of the present invention. The thus illustrated despreading and interference detection operations 800 correspond to S250, S260 and S270 of FIG. 2 and/or block 350 of FIG. 3.

As shown in FIG. 8, the despreading and interference detection operations 800 according to embodiments of the present invention may comprise an inputting phase 810, a correlation and despreading phase 820 and a detection phase 830. In the illustrated example, it is assumed that synchronized data subject to user code spreading with code group (1,1) is input, i.e. cell 1 or the cell corresponding to code groups (1,1*) through (1,K*) representing the subject cell, while a total of (7×K*) code groups are available in the system, i.e. K* code groups for each of 7 code group sets (for individual cells).

As shown in FIG. 8, the input signal is correlated and despreaded using all available code groups, while the inter-cell interference information detection is mandatorily effected for code groups (i.e. users) not belonging to the subject cell (e.g. code groups (2,1*) through (7,K*)) and only optionally effected for code groups (i.e. users) belonging to the subject cell (e.g. code groups (1,1*) through (1,K*)). The despreaded signals corresponding to the code groups of the subject cell are forwarded for the further signal processing towards user data detection, while the detected inter-cell interference information corresponding to the code groups of the neighboring cells (and optionally corresponding to the code groups of the subject cell) are forwarded as control data, e.g. to subcarrier level equalization and user data detection.

Accordingly, the interference detection according to embodiments of the present invention is performed (at least) on the basis of those user-related despreaded signals which correspond to a user-specific spreading code of a user of a neighboring cell.

As mentioned above, the despreading operation could be carried out after the initial uplink synchronization. So, at least at the beginning, for each individual user, the base station may have a different starting time point for the despreading. For synchronized uplink users, i.e. UEs being served by the BS in question, the same starting point may be used due to (uplink) synchronization. For the synchronized uplink users, the despreading is carried out, but the detection process is optional, since those users are synchronized already. That is, the base station is aware of the codes and code groups used for the synchronized users, and will not use them for the detection, if not required or desired for some reason. The detection is always carried out for the codes which are not used in this cell.

The interference detection is carried out after the despreading operation. There could be several ways to determine the interference timing and the relative power. After the timing/power (and user information) has been obtained, these will be given to different functional blocks for the corresponding interference cancellation and coordination processes, as evident from FIG. 3 and detailed below.

According to embodiments of the present invention, the interference detection may be performed in the time domain or the frequency domain.

In the time domain, since a code group may be used for the interference detection, there may be multiple (at least two) peaks with comparable peak values. The detection algorithm may thus be as follows.

First, the peaks are scanned over at least two IFDMA symbol durations, and the first 4 significant ones are selected (assuming that two codes per code group are used). Then, the relative positions of the 4 selected peaks are checked to determine the possible symbol or frame timing. Only when all the relative positions of the 4 selected peaks are correct (i.e. same as the pre-defined distance), the symbol/frame timing is found. Otherwise, a correlation window is moved further by a defined step (which can be one sample, or half of the IFDMA symbol duration), and the scanning and checking processes are repeated with the shifted correlation window. Once the symbol/frame timing is found, the peaks are averaged and compared to their own signal strength, in order to define the relative interference power. It is also possible to use the average over multiple scans to give more reliable results in case of low SNR (if the processing gain is not good enough). That is, some past results may be used for a current detection. However, the past results could be used only if they are valid (i.e. when the checking process is carried out successfully). After the frame/symbol timing and the power have been found, the interferer's identification can also be determined, since the correlation codes are user-specific. The base station can exchange interferer's information between neighboring base stations (using an X2 or similar connection).

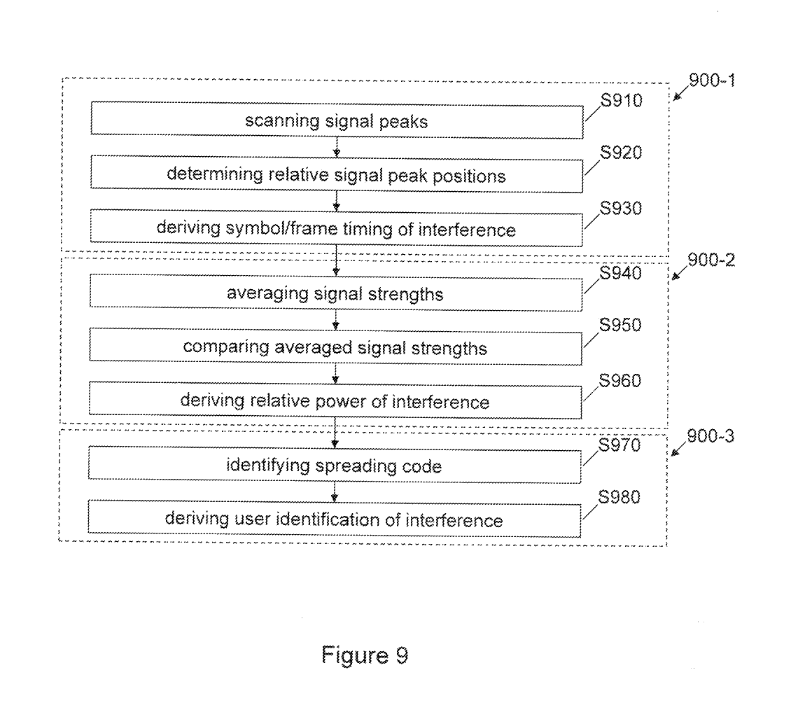

FIG. 9 shows a flow chart of an interference detection procedure according to embodiments of the present invention.

In FIG. 9, a detection process for inter-cell interference timing is denoted by 900-1, a detection process for inter-cell interference power is denoted by 900-2, and a detection process for inter-cell interference user identification is denoted by 900-3. It is noted that an interference detection operation according to embodiments of the present invention may also comprise only detection processes 900-1 and 900-2 or only detection processes 900-1 and 900-3, or detection processes 900-2 and 900-3 may be performed in a different sequence.

The detection process 900-1 may comprise an operation (S910) of scanning signal peaks over at least two periods of IFDMA symbol duration, an operation (S920) of determining relative positions of a predetermined number of scanned signal peaks, for which the related spreading code corresponds to a user of a neighboring cell, and an operation (S930) of deriving a symbol or frame timing of inter-cell interference from the determined relative positions.

The detection process 900-2 may comprise an operation (S940) of averaging signal strengths of the signal peaks used in deriving the symbol or frame timing of inter-cell interference in one or more signal peak scanning cycles, an operation (S950) of comparing the averaged signal strength with a signal strength of a signal peak, for which the related spreading code corresponds to a user of the subject cell, and an operation (S960) of deriving a relative power of inter-cell interference from a comparison result.

The detection process 900-3 may comprise an operation (S970) of identifying a user-specific spreading code relating to the predetermined number of scanned signal peaks, and an operation (S980) of deriving a user identification of inter-cell interference from the identified user-specific spreading code.

In the frequency domain, the CAZAC (ZC) codes may be applied both for the interference frame/symbol timing and power detection and the user identification. Thus, the multiple user/interference detection and identification can also be carried out in the frequency domain simultaneously, which may be effected in a manner similar to a conventional PRACH detection process.

According to embodiments of the present invention, the detected inter-cell interference information may be applied for at least one of inter-cell interference cancellation, inter-cell interference coordination, and coordinated handover, wherein the inter-cell interference cancellation may comprise at least one of time domain equalization and frequency domain equalization, and/or the inter-cell interference coordination may comprise at least one of dynamic resource scheduling and a coordinated handover. Details thereof are given below.

For interference cancellation, the detected information can be used either in the time domain or in the frequency domain. Time domain equalization may be effected with a multi-tap equalizer similar to a multi-tap equalizer for the multipath fading channels. The filter (equalizer) structure (number of taps, delay of individual taps, and the weight of individual taps) may be (at least partially) based on (and updated by) the information obtained from the time domain despreading. In fact, this equalizer could be allocated in the time domain directly after the CP removal (but before the multicarrier demodulation). Then the frequency domain equalization would be easier, since the interference part has been (partially) removed. A frequency domain equalization may be effected based on the fact that, when the interference timing has been found out, it can also be transferred into the frequency domain (at subcarrier level) by the multicarrier demodulation. Then, by subtracting this part from the main input (at subcarrier level after FFT demodulation), the interference can also be partially removed. After this operation, the subcarrier level equalization can be carried out normally.

For interference coordination, it may be utilized that the interference detection is based on the spreading codes attached to data transmitted, which is why it reflects the instant situation which could be valuable for the dynamic resource scheduling. The process steps in this regard could be as follows. Based on the interference power estimation and interference identification, the base station identifies the most significant interference and their affected users. The base stations could exchange the relative information. The base stations could then schedule the resources according to the sharing of the interference information. This may for example be accomplished based on the following regulations: If the timing difference of two interfering users (from two cells) are small enough so that CP can be used for absorbing the asynchronization effect, these two users should use different resources. If the timing difference of two interfering users (from two cells) are larger so that CP cannot be used for absorbing the asynchronization effect, these two users should use different resources with enough separations (for instance, the two consecutive subcarriers cannot be given to those users, since the resource separation would be too small). In general, all the four cases (of two interfering users with two links) should use different resources to address possible TDD mismatching.

For coordinated handover (for interference coordination), when the correlation (despreading) shows that the interference is very significant from a single user and the timing correlation shows that the CP cannot absorb the asynchronization effect of the interference user, there could be a critical near-far effect due to TDD mismatching. That is, the downlink signal from a base station can be fully masked by the nearby interference user which may use full power for the uplink transmission (since it is usually located at the cell edge). The front end performance of the receiver at the BS could be destroyed by the very strong out-band signal. In this case, these two users from different cells, i.e. the user of the subject cell and the interference user of the neighboring cell, have to be synchronized with each other. So, a handover is needed for switching these two users to the same base station, e.g. switching the interference user of the neighboring cell to the subject cell. The process steps in this regard could be as follows.

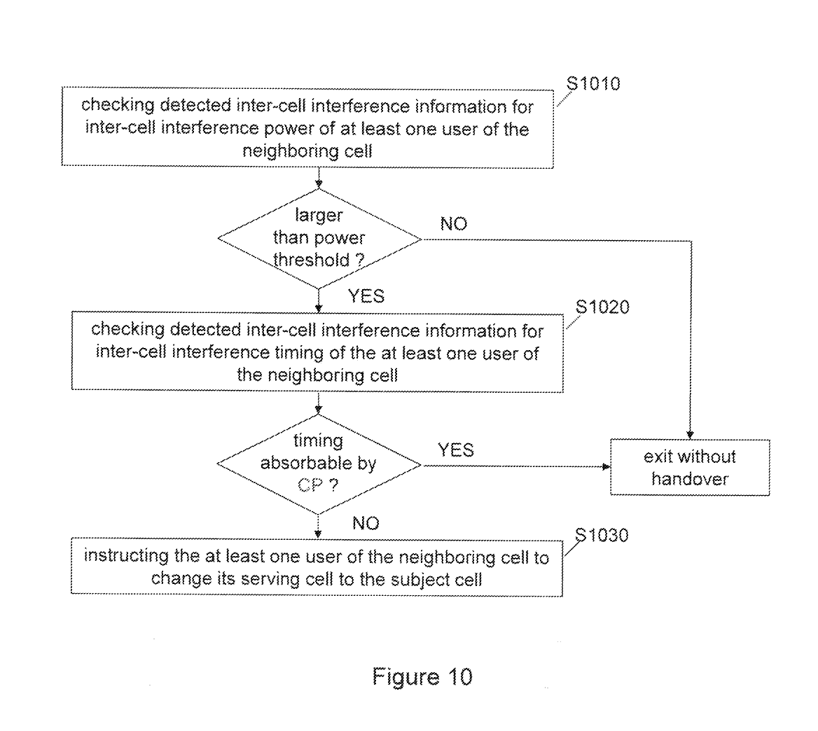

FIG. 10 shows a flow chart of a coordinated handover operation according to embodiments of the present invention. Such procedure is operable at the network side of a cellular system, i.e. at a base station (denoted by BS) such as an access point, an eNB, a home eNB, etc. or modem thereof.

As shown in FIG. 10, the coordinated handover procedure according to embodiments of the present invention may comprise an operation (S1010) of checking said detected inter-cell interference information for inter-cell interference power of at least one user of the neighboring cell, an operation (S1020) of checking said detected inter-cell interference information for inter-cell interference timing of the at least one user of the neighboring cell, whose inter-cell interference power exceeds a predetermined power threshold, and an operation (S1030) of instructing the at least one user of the neighboring cell, whose inter-cell interference timing will/cannot be absorbed below a predetermined timing threshold by inserting a cyclic prefix in the code-spreaded interleaved frequency division multiple access signal, to change its serving cell to the subject cell.

Namely, it is first checked, if there is (are) significant interference source(s), i.e. at least one user of a neighboring cell causing an excessive inter-cell interference power (above some power threshold). Then, if there is/are one (or more) significant interference source(s), i.e. at least one interfering neighboring cell user, the timing information of the thus identified user or users is checked. If the CP can help, i.e. when it is determined that CP insertion in the code-spreaded IFDMA signal is capable of sufficiently absorbing the inter-cell interference timing, e.g. that the inter-cell interference timing falls below some timing threshold by the CP, then no handover is needed. If the CP cannot help, i.e. when it is determined that CP insertion in the code-spreaded IFDMA signal is not capable of sufficiently absorbing the inter-cell interference timing, e.g. that the inter-cell interference timing is maintained above the timing threshold despite the CP, then one (or several) user(s), corresponding to the thus negatively checked inter-cell interference timing information, has/have to change its (their) serving cell(s) so that they belong to the same cell, e.g. the subject cell. Then, this user (these users) is (are) instructed accordingly. Since the timing information and identification information is already known by base stations, the handover can be carried out smoothly.

In general, there could be several cases in which the coordinated handover could be used. In a first case, a user is moving to the cell edge so that the user from another cell has detected the increased interference power which may exceed the coordinated handover power/timing threshold. In this case, the previously outlined process steps for a coordinated handover can be used. In a second case, a user activation will induce an instant strong inter-cell interference. In this case, the serving base station has to be chosen properly before the activation of the user. In the worst case, some activated users may have to switch their serving station in advanced. In a third case, a user's normal handover may induce an instant strong inter-cell interference. In this case, the serving base station has to evaluate the (nearby) users at the cell edge. If there are some users having similar powers and they are close to each other, the serving and target base stations may postpone the handover.

The coordinated handover power/timing threshold has/have to be chosen so that the coordinated handover will not propagate. That is, the coordinated handover may be a failure if the users are distributed as a cluster (from the cell center to the cell edge). In this case, there could be a hard decision to limit the use of coordinated handover only at the cell edge.

By virtue of embodiments of the present invention, as explained above, accurate and prompt inter-cell interference detection in a multi-cell environment (in/for cellular communication systems) is realized. The accurate and prompt detection of inter-cell interference information is based on the IFDMA technique being supplemented by time domain user code spreading. The time domain user code spreading is effected after multi-carrier modulation in the time domain, and the chips of the codes are not repeated in the time domain. With the detected inter-cell interference information, interference cancellation and coordination schemes can be applied in a more effective manner. The user-specific time domain spreading of an IFDMA signal is effective for interference detection (in terms of timing, power and user, for example). Various code selection schemes and allocation schemes (in the time domain) are effective for the interference detection as well. The interference detection algorithms are based on IFDMA time domain despreading. Various interference cancellation/coordination schemes (including coordinated handover) can be based on the interference detection information obtained from time domain IFDMA despreading.

By virtue of embodiments of the present invention, at least the following advantages and beneficial technical effects can be achieved.

By way of utilizing an IFDMA data signal for time domain spreading, accurate inter-cell interference detection can be achieved. This results from the fact that the IFDMA signal is constant (unlike e.g. OFDM), and is specifically effective when the channel is flat in time, such as the LA channel (due to the low speed movement). Further, fast/instant inter-cell interference detection can be achieved, especially in terms of interference (frame) timing and (relative) power. This results from the fact that the spreading is effected solely for the data transmission.

By way of utilizing group/multiple codes combinations, interference detection reliability can be improved. This results from the fact that the data is repeated in one SC-FDMA (IFDMA) symbol. The group code combination also gives freedom for algorithm design.

By way of utilizing the detected interference information for interference cancellation and/or coordination function, the instant detection can provide necessary information for, for example, fast updates of the parameters for interference cancellation algorithms, dynamic resource scheduling for interference coordination algorithms, and fast coordinated handover, if needed.

The additional spreading and despreading operations at the TX and RX sides do not induce any significant implementation issues (such as complexity and cost). In fact, time domain spreading of an IFDMA signal is most efficient to obtain the necessary information for anti-interference processes.

The IFDMA-based time domain spreading according to embodiments of the present invention is effective and applicable for LTE®/LTE-A LA network/environment scenarios (3.5G band). Such access/modulation schemes exhibit various advantages/benefits as compared with currently used OFDMA/SC-FDMA schemes (for conventional LTE®). This is due to the following reasons.

Firstly, IFDMA has a similar architecture to OFDMA, with a very limited extra cost of complexity. It is well known that SC-FDMA (LFDMA and IFDMA) just need an extra DFT per (de-)coding/(de-)spreading pair, when compared to the basic OFDMA scheme. All of them can apply the simple one tap frequency domain channel estimation. For SC-FDMA, the channel equalization could be a bit more complicated, since it could make the final decision after DFT despreading.

Secondly, the extra hardware and/or software complexity induced by the time domain spreading/despreading operation is very limited. At the TX side, the spreading does not increase the TX signal band (so it is a kind of scrambling). At the RX side, the despreading operation can be identical/equivalent to the initial synchronization process, so the RX side does not need any extra hardware/software. A potential problem in this regard could be the efficient use of power, since the correlations have to be carried out frequently over a large number of codes. This would however likely not be a critical problem, if such a scheme is only used for UL, since such a process is carried out only in the BS (or another fixed network node). Thus, the overall complexity could be very similar among OFDMA, LFDMA, and IFDMA with time domain spreading.

Thirdly, due to the similarity of OFDMA and SC-FDMA, most numerology can be the same for those two schemes, which is similar to current LTE®. This means that some of OFDMA parameters concerning the frame architecture (as defined in corresponding LTE® specifications), such as frame/slot duration, symbol duration, and the like, can be reused for IFDMA.

Fourthly, IFDMA provides the best PAPR among different multi-carrier schemes (namely, OFDMA, LFDMA, MC-CDMA, and IFDMA). The general understanding is that for LTE®/LTE-A LA, PAPR could not represent a significant problem due to the low power transmission. However, such a conclusion is only valid if the total number of subcarriers is limited (such as 1024 or smaller). For a system using a large FFT size (such as 2048 in case of LTE® at 20 MHz bandwidth), the PAPR could actually represent a problem, since there is a few decibels difference between the high-power amplifier backoff values of OFDMA and IFDMA. Such a difference will help directly in improving cell throughput, saving battery life, or the like.

Fifthly, especially in the LA environment and similar environments, the overall pilot overhead is reduced (since the channel response is relatively flat), so the main drawback of using IFDMA (namely, high pilot overhead in frequency) is less significant.

Sixthly, unlike OFDMA, IFDMA cannot use subcarrier level dynamic scheduling. However, such a potential drawback is compensated for by advantages of IFDMA-based time domain spreading, such as the following. The IFDMA-based time domain spreading can track the channel and interference instantly, which is why the delay of (mainly channel and interference related) information exchange between nodes and terminals can be minimized. This may be a critical problem in current LTE®/LTE-A ICIC design. With appropriate control signal design, better information accuracy and faster information exchange than in OFDMA can be provided. This improvement could be even more significant in asynchronized cases. Further, IFDMA provides diversity gain (if there is one), since it utilizes the subcarriers over the full bandwidth. This may not be a significant issue for LA environments, but for other applicable environments. Still further, since code domain design is usually interference limited design, it provides a flexibility of spectrum overlapping. In this case, it gives some freedom to arrange the interference not only in the time and frequency domains, but also in the code domain.

Generally, the above-described procedures and functions may be implemented by respective functional elements, processors, or the like, as described below.

While in the foregoing embodiments of the present invention are described mainly with reference to methods, procedures and functions, corresponding embodiments of the present invention also cover respective apparatuses, network nodes and systems, including both software, algorithms, and/or hardware thereof.

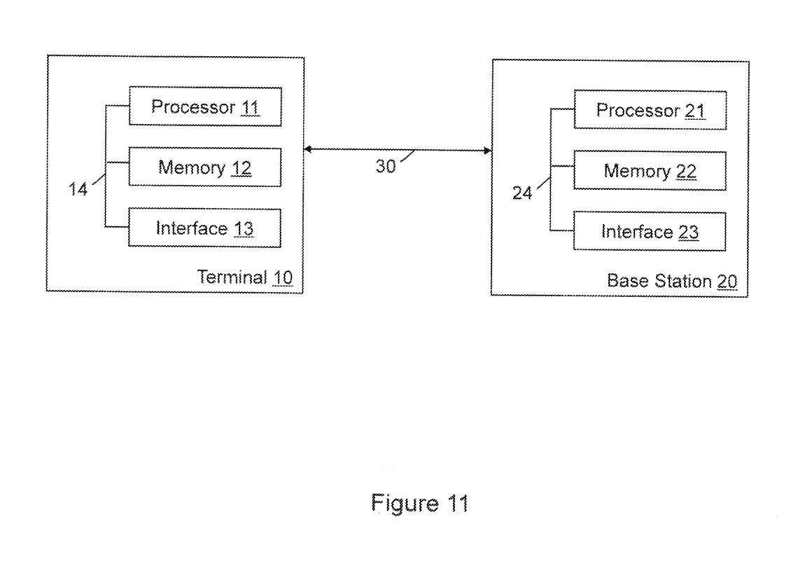

Respective embodiments of the present invention are described below referring to FIG. 11, while for the sake of brevity reference is made to the detailed description with regard to FIGS. 1 to 10.

In FIG. 11 below, which is noted to represent a simplified block diagram, the solid line blocks are configured to perform respective operations as described above. The entirety of solid line blocks are configured to perform the methods and operations as described above, respectively. With respect to FIG. 11, it is to be noted that the individual blocks are meant to illustrate respective functional blocks implementing a respective function, process or procedure, respectively. Such functional blocks are implementation-independent, i.e. may be implemented by means of any kind of hardware or software, respectively. The arrows and lines interconnecting individual blocks are meant to illustrate an operational coupling there-between, which may be a physical and/or logical coupling, which on the one hand is implementation-independent (e.g. wired or wireless) and on the other hand may also comprise an arbitrary number of intermediary functional entities not shown. The direction of an arrow is meant to illustrate the direction in which certain operations are performed and/or the direction in which certain data is transferred.

Further, in FIG. 11, only those functional blocks are illustrated which relate to any one of the above-described methods, procedures and functions. A skilled person will acknowledge the presence of any other conventional functional blocks required for an operation of respective structural arrangements, such as e.g. a power supply, a central processing unit, respective memories or the like. Among others, memories are provided for storing programs or program instructions for controlling the individual functional entities to operate as described herein.

FIG. 11 shows a schematic block diagram of apparatus according to embodiments of the present invention.

In view of the above, the thus illustrated apparatuses 10 and 20 are suitable for use in practicing embodiments of the present invention, as described herein.

The thus illustrated apparatus 10 may represent a (part of a) device or terminal such as a mobile station or user equipment or a modem (which may be installed as part thereof, but may be also a separate module, which can be attached to various devices), and may be configured to provide for a functionality/operability and/or exhibit a configuration as described in conjunction with any one of FIGS. 2 and 3. The apparatus may be implemented by, at or in any kind of communication element, especially but not exclusively any kind of mobile/wireless communication element, such as e.g. a mobile device, a mobile station, a user equipment, a telephone, a smartphone, a communicator, a (handheld) computer, a vehicle-mounted/based device, a navigation-related device, a server or a device with server functionality, and so on, respectively.

The thus illustrated apparatus 20 may represent a (part of a) network entity, such as a base station or access node or any network-based controller, e.g. an eNB, or a modem (which may be installed as part thereof, but may be also a separate module, which can be attached to various devices), and may be configured to provide for a functionality/operability and/or exhibit a configuration as described in conjunction with any of FIGS. 2, 3, and 8 to 10. The apparatus may be implemented by, at or in any kind of communication control element, such as e.g. a base station (e.g. of a macro, micro, pico, femto cell), a NodeB, an eNodeB, home eNodeB, an access point, WLAN access point, and so on, respectively.

As indicated in FIG. 11, according to embodiments of the present invention, each of the apparatuses comprises a processing system and/or processor 11/21, a memory 12/22 and an interface 13/23, which are connected by a bus 14/24 or the like, and the apparatuses may be connected via link 30, respectively.

The processing system and/or processor 11/21 and/or the interface 13/23 may also include a modem or the like to facilitate communication over a (hardwire or wireless) link, respectively. The interface 13/23 may include a suitable transceiver coupled to one or more antennas or communication means for (hardwire or wireless) communications with the linked or connected device(s), respectively. The interface 13/23 is generally configured to communicate with at least one other apparatus, i.e. the interface thereof.

The memory 12/22 may store respective programs assumed to include program instructions or computer program code that, when executed by the respective processing system and/or processor, enables the respective electronic device or apparatus to operate in accordance with embodiments of the present invention. Also, the memory 12/22 may store parameters, values, and the like, which are effective for a corresponding operation. For example, the memory 22 may store a mapping between user coded and users/UEs being served by the respective BS or the like, the memory 12/22 may store information on code selection/grouping schemed, code allocations, and the like.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processing system and/or processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

In its most basic form, according to embodiments of the present invention, the apparatus 10 or its processing system and/or processor 11 is configured to perform generating an interleaved frequency division multiple access signal for user data, spreading, in the time domain, the generated interleaved frequency division multiple access signal using a user-specific spreading code of a user of a subject cell, and outputting the code-spreaded interleaved frequency division multiple access signal for transmission in the subject cell.

In its most basic form, according to embodiments of the present invention, the apparatus 20 or its processing system and/or processor 21 is configured to perform inputting a code-spreaded interleaved frequency division multiple access signal, despreading the inputted signal using a plurality of user-specific spreading codes including at least one spreading code of a user of a subject cell and at least one spreading code of a user of a neighboring cell, and detecting inter-cell interference information on the basis of user-related despreaded signals.

For further details regarding the operability/functionality of the individual apparatuses, reference is made to the above description in connection with any one of FIGS. 1 to 10, respectively.

According to embodiments of the present invention, a system may comprise any conceivable combination of (one or more of) the thus depicted devices/apparatuses and other network elements, which are configured to cooperate with any one of them.

In general, it is to be noted that respective functional blocks or elements according to above-described aspects can be implemented by any known means, either in hardware and/or software/firmware, respectively, if it is only adapted to perform the described functions of the respective parts. The mentioned method steps can be realized in individual functional blocks or by individual devices, or one or more of the method steps can be realized in a single functional block or by a single device.

Generally, any structural means such as a processing system and/or processor or other circuitry may refer to one or more of the following: (a) hardware-only circuit implementations (such as implementations in only analog and/or digital circuitry) and (b) combinations of circuits and software (and/or firmware), such as (as applicable): (i) a combination of processor(s) or (ii) portions of processor(s)/software (including digital signal processor(s)), software, and memory(ies) that work together to cause an apparatus, such as a mobile phone or server, to perform various functions) and (c) circuits, such as a microprocessor(s) or a portion of a microprocessor(s), that require software or firmware for operation, even if the software or firmware is not physically present. Also, it may also cover an implementation of merely a processor (or multiple processors) or portion of a processor and its (or their) accompanying software and/or firmware, any integrated circuit, or the like.

Generally, any procedural step or functionality is suitable to be implemented as software/firmware or by hardware without changing the ideas of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, or a (hardware) module comprising such chip or chipset; this, however, does not exclude the possibility that a functionality of a device/apparatus or module, instead of being hardware implemented, can be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, the present invention and/or embodiments thereof provide measures for enabling accurate and prompt inter-cell interference detection in a multi-cell environment. Such measures may comprise, at a network side of a cellular system, inputting a code-spreaded interleaved frequency division multiple access signal, despreading the inputted signal using a plurality of user-specific spreading codes including at least one spreading code of a user of a subject cell and at least one spreading code of a user of a neighboring cell, and detecting inter-cell interference information on the basis of user-related despreaded signals.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

### LIST OF ACRONYMS AND ABBREVIATIONS

### 3GPP Third Generation Partnership Project

### BS Base Station

### CAZAC Constant Amplitude Zero Autocorrelation Code

### CDMA Code Division Multiple Access

### CP Cyclic Prefix

### DFDMA Distributed Frequency Division Multiple Access

### DFT Discrete Fourier Transform

eNB evolved Node B (E-UTRAN base station)

### E-UTRAN Evolved UTRAN

### FDMA Frequency Division Multiple Access

### FFT Fast Fourier Transform

### ICI Inter Carrier/Channel Interference

### ICIC Inter Cell Interference Cancellation/Coordination

### IEEE Institute of Electrical and Electronics Engineers

### IFDMA Interleaved FDMA

### IFFT Inverse Fast Fourier Transform

### ISI Inter Symbol Interference

### LA Local Area

### LFDMA Localized Frequency Division Multiple Access

### LTE® Long Term Evolution

### LTE-A Long Term Evolution Advanced

### MC-CDMA Multi-Carrier CDMA

### OFDM Orthogonal Frequency Division Multiplex

### OFDMA Orthogonal Frequency Division Multiple Access

### PAPR Peak to Average Power Ratio

### PRACH Physical Random Access Channel

P/S Parallel to Serial conversion

### RAT Radio Access Technology

### RX Receiver/Reception

### SC-FDMA Single-Carrier FDMA

### SNR Signal-to-Noise Ratio

### TDD Time Domain Division

### TX Transmitter/Transmission

### UE User Equipment

### UTRAN Universal Terrestrial Radio Access Network

### WH Walsh-Hadamard

### ZC Zadoff-Chu

WLAN Wireless Local Area Network

What is claimed is:

1. A method comprising:
inputting a code-spreaded interleaved frequency division multiple access signal;
despreading the inputted signal using a plurality of user-specific spreading codes including at least one spreading code of a user of a subject cell and at least one spreading code of a user of a neighboring cell; and
detecting inter-cell interference information on the basis of user-related despreaded signals.

2. The method according to claim 1, wherein said inputting and/or said despreading is based on time synchronization in the subject cell, and/or
said detecting is performed on the basis of those user-related despreaded signals which correspond to a user-specific spreading code of a user of a neighboring cell.

3. The method according to claim 1, wherein:
said detecting is performed in the time domain or the frequency domain, and/or
said detecting comprises:
scanning signal peaks over at least two periods of interleaved frequency division multiple access symbol duration;
determining relative positions of a predetermined number of scanned signal peaks for which the related spreading code corresponds to a user of a neighboring cell; and
deriving a symbol or frame timing of inter-cell interference from the determined relative positions.

4. The method according to claim 1, wherein said user-specific spreading code comprises a group of at least two codes, and in the group of at least two codes:
different CAZAC codes are dedicated for detection of inter-cell interference timing, inter-cell interference power, and inter-cell interference user identification, or
a CAZAC code or an m sequence is dedicated for detection of inter-cell interference timing and inter-cell interference power, and a WH code is dedicated for detection of inter-cell interference user identification, or
a root index of a CAZAC code is dedicated for detection of inter-cell interference timing and inter-cell interference power, and a cyclic shift of the CAZAC code is dedicated for detection of inter-cell interference user identification.

5. The method according to claim 1, further comprising applying said detected inter-cell interference information for at least one of inter-cell interference cancellation, inter-cell interference coordination, and coordinated handover.

6. The method according to claim 5, wherein:
the inter-cell interference cancellation comprises at least one of time domain equalization and frequency domain equalization, and/or
the inter-cell interference coordination comprises at least one of dynamic resource scheduling and a coordinated handover; and/or
the coordinated handover comprises:
checking said detected inter-cell interference information for inter-cell interference power of at least one user of the neighboring cell;
checking said detected inter-cell interference information for inter-cell interference timing of the at least one user of the neighboring cell, whose inter-cell interference power exceeds a predetermined power threshold; and
instructing the at least one user of the neighboring cell, whose inter-cell interference timing will not be absorbed below a predetermined timing threshold by inserting a cyclic prefix in the code-spreaded interleaved frequency division multiple access signal, to change its serving cell to the subject cell.

7. A method comprising:
generating an interleaved frequency division multiple access signal for user data;
spreading, in the time domain, the generated interleaved frequency division multiple access signal using a user-specific spreading code of a user of a subject cell; and
outputting the code-spreaded interleaved frequency division multiple access signal for transmission in the subject cell.

8. The method according to claim 7, wherein:
said outputting and/or said transmission is based on time synchronization in the subject cell; and/or
a spreading factor or a number of chips of said user-specific spreading code is equal to a time domain symbol repetition value of a user data time domain symbol in a combined single-carrier frequency division multiple access signal symbol of the interleaved frequency division multiple access signal; and/or
said user-specific spreading code is allocated in a localized allocation or a distributed allocation with respect to time domain symbols in a symbol repetition set of time domain symbols.

9. The method according to claim 7, wherein said user-specific spreading code comprises a group of at least two codes, and in the group of at least two codes:
different CAZAC codes are used, or
a CAZAC code or an m sequence and a WH code are used, or
a root index of a CAZAC code and a cyclic shift of the CAZAC code are used.

10. The method according to claim 7, wherein:
the outputting comprises inserting a cyclic prefix in the code-spreaded interleaved frequency division multiple access signal, or
the generating comprises inserting a cyclic prefix in the interleaved frequency division multiple access signal.

11. An apparatus comprising:
at least one processor,
at least one memory including computer program code, and
at least one interface configured for communication with at least another apparatus,
the at least one processor, with the at least one memory and the computer program code, being configured to cause the apparatus to at least:
input a code-spreaded interleaved frequency division multiple access signal;
despread the inputted signal using a plurality of user-specific spreading codes including at least one spreading code of a user of a subject cell and at least one spreading code of a user of a neighboring cell; and
detect inter-cell interference information on the basis of user-related despreaded signals.

12. The apparatus according to claim 11, wherein the at least one processor, with the at least one memory and the computer program code, is configured to cause the apparatus to perform:
said inputting and/or said despreading based on time synchronization in the subject cell, and/or
said detecting on the basis of those user-related despreaded signals which correspond to a user-specific spreading code of a user of a neighboring cell.

13. The apparatus according to claim 11, wherein the at least one processor, with the at least one memory and the computer program code, is configured to cause the apparatus:
to perform said detecting in the time domain or the frequency domain; and/or
to perform said detecting by:
scanning signal peaks over at least two periods of interleaved frequency division multiple access symbol duration;
determining relative positions of a predetermined number of scanned signal peaks for which the related spreading code corresponds to a user of a neighboring cell; and
deriving a symbol or frame timing of inter-cell interference from the determined relative positions.

14. The apparatus according to claim 11, wherein said user-specific spreading code comprises a group of at least two codes, and in the group of at least two codes:
different CAZAC codes are dedicated for detection of inter-cell interference timing, inter-cell interference power, and inter-cell interference user identification, or
a CAZAC code or an m sequence is dedicated for detection of inter-cell interference timing and inter-cell interference power, and a WH code is dedicated for detection of inter-cell interference user identification, or
a root index of a CAZAC code is dedicated for detection of inter-cell interference timing and inter-cell interference power, and a cyclic shift of the CAZAC code is dedicated for detection of inter-cell interference user identification.

15. The apparatus according to claim 11, wherein the at least one processor, with the at least one memory and the computer program code, is configured to cause the apparatus to apply said detected inter-cell interference information for at least one of inter-cell interference cancellation, inter-cell interference coordination, and coordinated handover.

16. The apparatus according to claim 15, wherein:
the inter-cell interference cancellation comprises at least one of time domain equalization and frequency domain equalization, and/or
the inter-cell interference coordination comprises at least one of dynamic resource scheduling and a coordinated handover, and/or
the at least one processor, with the at least one memory and the computer program code, is configured to cause the apparatus to perform the coordinated handover by:
checking said detected inter-cell interference information for inter-cell interference power of at least one user of the neighboring cell;
checking said detected inter-cell interference information for inter-cell interference timing of the at least one user of the neighboring cell whose inter-cell interference power exceeds a predetermined power threshold; and
instructing the at least one user of the neighboring cell, whose inter-cell interference timing will not be absorbed below a predetermined timing threshold by inserting a cyclic prefix in the code-spreaded interleaved frequency division multiple access signal, to change its serving cell to the subject cell.

17. An apparatus comprising:
at least one processor,
at least one memory including computer program code, and
at least one interface configured for communication with at least another apparatus,
the at least one processor, with the at least one memory and the computer program code, being configured to cause the apparatus to at least:
generate an interleaved frequency division multiple access signal for user data;
spread, in the time domain, the generated interleaved frequency division multiple access signal using a user-specific spreading code of a user of a subject cell; and
output the code-spreaded interleaved frequency division multiple access signal for transmission in the subject cell.

18. The apparatus according to claim 17, wherein:
the at least one processor, with the at least one memory and the computer program code, is configured to cause the apparatus to perform said outputting and/or said transmission based on time synchronization in the subject cell, and/or
a spreading factor or a number of chips of said user-specific spreading code is equal to a time domain symbol repetition value of a user data time domain symbol in a combined single-carrier frequency division multiple access signal symbol of the interleaved frequency division multiple access signal, and/or
said user-specific spreading code is allocated in a localized allocation or a distributed allocation with respect to time domain symbols in a symbol repetition set of time domain symbols.

19. The apparatus according to claim 17, wherein said user-specific spreading code comprises a group of at least two codes, and the at least one processor, with the at least one memory and the computer program code, is configured to cause the apparatus to perform said spreading by using, in the group of at least two codes:
different CAZAC codes, or
a CAZAC code or an m sequence and a WH code, or
a root index of a CAZAC code and a cyclic shift of the CAZAC code.

20. The apparatus according to claim 17, wherein the at least one processor, with the at least one memory and the computer program code, is configured to cause the apparatus to:
insert a cyclic prefix in the code-spreaded interleaved frequency division multiple access signal in said outputting; or
insert a cyclic prefix in the interleaved frequency division multiple access signal in said generating.
